(19) United States
(12) Patent Application Publication
(10) Pub. No.: US 2017/0301203 A1
(43) Pub. Date: Oct. 19, 2017

(54) REDUCING BANDWIDTH VIA VOICE DETECTION

(71) Applicant: Vivint, Inc., Provo, UT (US)

(72) Inventor: Craig Matsuura, Draper, UT (US)

(21) Appl. No.: 15/099,762

(22) Filed: Apr. 15, 2016

(51) Int. Cl. G08B 13/196; G10L 25/84; G08B 13/16; G10L 25/78

(52) U.S. Cl. CPC G08B 13/19656; G10L 25/84; G08B 13/1672; G08B 13/19695; G10L 2025/783

(57) ABSTRACT

A method for an automation system is described. In one embodiment, the method includes monitoring for detection of sound via a microphone on a security camera. The security camera is configured to generate an audio stream and a video stream and to transmit the audio and video streams via a transmitter associated with the security camera. Upon detecting sound via the microphone, the method includes determining whether the sound includes a human voice and, upon determining the sound includes the human voice, modifying at least one aspect of the audio or video streams of the security camera.

### BACKGROUND

The present disclosure, for example, relates to security and/or automation systems, and more particularly to reducing bandwidth in such systems via voice detection.

Security and automation systems are widely deployed to provide various types of communication and functional features such as monitoring, communication, notification, and/or others. These systems may be capable of supporting communication with a user through a communication connection or a system management action.

Security and/or automation systems may be configured to communicate over a communication network of a premises such as a home, school, or office. Such systems may deploy one or more security cameras. Each security camera may communicate captured data to a control panel via the communication network. The security camera may continually communicate a video stream and/or audio stream to the control panel. Such continual streaming may consume a considerable amount of bandwidth available to the communication network. Typically, most of the data that consumes this bandwidth is eventually discarded, meaning much of the consumed bandwidth is wasted. Moreover, continual consumption of bandwidth may degrade the performance of the communication network.

### SUMMARY

The present disclosure provides description of systems and methods configured to reduce bandwidth usage in relation to an automation system, which may include a security system. A premises, such as a home, office, school, etc., may include one or more security cameras as part of an automation system. In some cases the security cameras may be configured to transmit by wire and/or wirelessly over a network a continual stream of video and/or audio to a central location of the automation system such as a control panel, thereby consuming a significant portion of the available bandwidth in the network. The present systems and methods reduce such bandwidth usage based on voice detection.

In one embodiment, a security camera in an automation system may be configured to capture video, images, and audio and transmit streams of the captured video, images, and audio to a control panel. A microphone of a security camera may detect sound in relation to the camera. The security camera, via a processor, may monitor the microphone for detection of a human voice. The security camera may have two or more modes.

The modes may include a detection mode (e.g., voice detected, sound detected, motion detected, etc.) and a no detection mode (e.g., no voice detected mode, no sound detected mode, no motion detected mode, etc.). In the no detection mode, the security camera may be configured to use minimal bandwidth. For example, the camera may send audio only to the control panel as long as no voice, sound, or motion is detected. In some cases, in this mode the camera may not send any video or images. If the camera sends any audio data in this low-bandwidth mode, the camera may send a low quality audio (e.g., audio sampling rate of 4 kHz, or 4-bit audio bit depth, etc.). Likewise, if the camera sends any video or image data in this mode, the camera may send a low quality video (e.g., image resolution of 320×240, video frame rate of 5 frame per second (fps), a 4-bit video color depth, etc.). In some cases, the camera may send a captured image at regular intervals in this mode.

In this mode or any mode, however, the camera may send video, images, and/or audio based on user request at any quality. For example, when the camera is in the no detection mode, the user may request video and audio streams at the highest available quality, resulting in the camera using the highest amount of bandwidth it is capable of using. Upon the user discarding the request (e.g., by closing the viewing application, etc.), the security camera may automatically switch back to the low-bandwidth-consuming mode without human intervention or human input.

Upon detecting sound, voice, and/or motion, the camera may switch to the detection mode, increasing the quality of one or more aspects of the video and audio streams. As one example, the camera may increase the audio sampling rate, increase the audio bit depth, increase the image resolution, increase the video frame rate, increase the video color depth, etc. Likewise, when the camera detects a human voice or motion, the camera may increase the quality of one or more aspects of the audio and/or video streams.

In some embodiments, the camera may monitor the available network bandwidth to determine available bandwidth, bandwidth limits, times of high bandwidth usage, etc. Accordingly, the camera may adjust its bandwidth usage in real-time based on a detected amount of available network bandwidth. The camera may determine whether the available bandwidth and/or bandwidth usage satisfies one or more thresholds. When available bandwidth exceeds the highest threshold, the camera may be configured to automatically switch to the highest bandwidth mode. When available bandwidth falls below the lowest threshold, the camera may be configured to automatically switch to the lowest bandwidth mode, etc.

In some cases, the camera may monitor for the detection of voice to determine whether the voice is known or unknown. For example, the camera may determine whether a detected voice is that of an occupant of the premises or an unknown visitor. Upon determining the voice is that of an occupant, the system may identify the occupant and perform one or more automation tasks associated with that occupant based on stored user preferences. Upon determining the voice is that of an unknown visitor, the camera may increase the quality of one or more aspects of the video and audio streams to capture and store data of the unknown visitor.

A method for an automation system is described. In one embodiment, the method may include monitoring for detection of sound via a microphone on a security camera. The security camera may be configured to generate an audio stream and a video stream and to transmit the audio and video streams via a transmitter associated with the security camera. Upon detecting sound via the microphone, the method may include determining whether the sound includes a human voice and, upon determining the sound includes the human voice, modifying at least one aspect of the audio or video streams of the security camera.

Upon determining the sound includes the human voice, the method may include adjusting an audio sampling rate of the audio stream, adjusting an image resolution of the video stream, and/or adjusting a video frame rate of the video stream. Upon determining the sound detected by the microphone falls below a sound threshold, the method may include configuring at least one of the audio and video streams to a default mode.

In some embodiments, the method may include monitoring a network to which the security camera is connected to determine the network's available bandwidth. Upon determining the sound detected by the microphone falls below a sound threshold, the method may include modifying at least one aspect of the audio or video streams of the security camera based on the available bandwidth. Upon determining the sound includes the human voice, the method may include modifying at least one aspect of the audio or video streams of the security camera regardless of the available bandwidth.

A method for triggering capture events based on audio detection is also described. In one embodiment, the method may include monitoring for detection of sound via a microphone on a security camera in a premises. The security camera may be configured to generate an audio stream via the microphone and to transmit the audio stream via a wireless transmitter. Upon detecting sound via the microphone, the method may include determining whether the sound includes a human voice, and, upon determining the sound includes the human voice, sending a command to a control panel to perform an automation action.

In some cases, upon identifying the detected human voice as a known voice, the method may include determining whether the known voice is associated with a first occupant or a second occupant of the premises. Upon determining the known voice is associated with the first occupant, the method may include sending a command to the control panel to perform a first automation action. Upon determining the known voice is associated with the second occupant, the method may include sending a command to the control panel to perform a second automation action. Upon identifying the detected human voice as an unknown voice, the method may include triggering a capture event in relation to the security camera.

An apparatus for security and/or automation systems is also described. The apparatus may include a processor, memory in electronic communication with the processor, and instructions stored in the memory. The instructions may be executable by the processor to monitor for detection of sound via a microphone on a security camera. The security camera may be configured to generate an audio stream and a video stream and to transmit the audio and video streams via a transmitter associated with the security camera. Upon detecting sound via the microphone, the instructions may be executable by the processor to determine whether the sound includes a human voice, and, upon determining the sound includes the human voice, the instructions may be executable by the processor to modify at least one aspect of the audio or video streams of the security camera.

The foregoing has outlined rather broadly the features and technical advantages of examples according to this disclosure so that the following detailed description may be better understood. Additional features and advantages will be described below. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein—including their organization and method of operation—together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following a first reference label with a dash and a second label that may distinguish among the similar components. However, features discussed for various components—including those having a dash and a second reference label—apply to other similar components. If only the first reference label is used in the specification, the description is applicable to any one of the similar components having the same first reference label irrespective of the second reference label.

FIG. 1 is a block diagram of an example of a security and/or automation system in accordance with various embodiments;

FIG. 2 shows a block diagram of a device relating to a security and/or an automation system, in accordance with various aspects of this disclosure;

FIG. 3 shows a block diagram of a device relating to a security and/or an automation system, in accordance with various aspects of this disclosure;

FIG. 4 shows a block diagram relating to a security and/or an automation system, in accordance with various aspects of this disclosure;

FIG. 5 is a flow chart illustrating an example of a method relating to a security and/or an automation system, in accordance with various aspects of this disclosure;

FIG. 6 is a flow chart illustrating an example of a method relating to a security and/or an automation system, in accordance with various aspects of this disclosure; and

FIG. 7 is a flow chart illustrating an example of a method relating to a security and/or an automation system, in accordance with various aspects of this disclosure.

### DETAILED DESCRIPTION

The following relates generally to improving home automation and security in a premises environment. The typical home security video camera is located in a central location. The typical security camera may be configured to be triggered to capture events. The trigger may be based on the detection of motion. Thus, upon detecting motion within the camera's field of view, the camera may be triggered to capture one or more images and a 30-second video, for example.

In some cases, the camera may be configured to operate continuously, 24 hours a day. Accordingly, such a video camera may send audio and video streams over a network, wired and/or wirelessly, to a centrally located control panel. The continuous stream of audio and video, however, may consume a significant portion of available bandwidth within the network, causing a reduction in the quality of service for other services competing for the same network bandwidth.

In addition to motion detection, the typical security camera also includes the ability for audio detection via a microphone. For example, in some cases, the present systems and methods may include configuring a security camera to trigger a capture event based on the detection of sound rather than or in addition to the detection of motion. For example, a command may be sent by the security camera to a control panel instructing the control panel to perform an automation action. Upon identifying the detected human voice as a known voice (e.g., the voice of an occupant of a premises), a control panel may be instructed to perform an automation action. In some embodiments, the security camera may be configured to detect human speech and/or the human voice and to identify a detected human voice as a recognized voice or an unrecognized voice. In some cases, the present systems and methods may determine whether the voice is associated with a first occupant or a second occupant of the premises. The control panel may be instructed to perform a first automation action if the voice is determined to be that of the first occupant. For example, the present systems and methods may include a database storing settings and preferences for one or more occupants of a premises. Thus, if the voice is determined to be that of the second occupant, the control panel may be instructed to perform a second automation action based on the stored preferences of the second occupant. In some cases, upon identifying the detected human voice as an unknown voice, the present systems and methods may trigger a capture event in relation to the security camera. Thus, in one embodiment, the present systems and methods incorporate the security camera microphone to enhance the triggering of capture events and/or automation actions.

In one embodiment, upon determining a detected sound includes a human voice, the system may be configured to modify at least one aspect of an audio and/or video stream transmitted by the security camera. A security camera transmitting continuous audio and video streams may consume significant portions of bandwidth in a given network, which may result in a reduced quality of service for each service competing to use a portion of the available bandwidth. Accordingly, in some embodiments, upon determining sound detected by the microphone satisfies a sound threshold, the security camera may stop generating an audio stream and/or stop generating a video stream. For example, upon determining sound detected by the microphone falls below a sound threshold, configuring the audio or video streams to a default mode. After detecting no sound or determining detectable sound falls below a predetermined threshold for a predetermined amount of time, then the security camera may be configured to automatically revert to a default video setting and/or audio setting. For example, by default, the security camera may transmit a relatively low quality video and/or audio streams. In some cases, the camera may transmit no video and/or audio stream by default. Upon detecting a human voice, the security camera may be configured to turn on and/or increase a quality of the video and/or audio streams. After detecting no sound, no human voice, and/or detectable sound falls below a predetermined threshold, the security camera may automatically revert to the default settings for the audio and/or video streams. Thus, without human intervention, without seeking human input, and/or without a notification or a prompt, the security camera may revert to a default setting once a human voice is not detected and/or detectable sound falls below the threshold. In some cases, the security camera may wait a predefined time after detecting the sound and/or a human voice via the microphone before automatically reverting to a default setting. Accordingly, the security camera's bandwidth usage may be minimized by reverting to a default setting after detecting sound and/or detecting a human voice.

In some embodiments, the security camera may adjust audio and/or video settings according to available network bandwidth. The security camera may monitor a network to determine available bandwidth. For example, the security camera may query a network device such as a router, switch, etc. to determine an amount of available network bandwidth. The security camera may adjust the audio and video settings based on the available network bandwidth. For example, when little to no sound is detected and/or a human voice is not detected and/or motion is not detected, the security camera may increase/decrease a quality of the audio and video streams according to the detected amount of available network bandwidth. If the bandwidth available on the network exceeds one or more bandwidth thresholds, the security camera may increase a quality aspect of the audio and/or video streams (e.g., audio sampling rate, audio bit rate, image resolution, video frame rate, video color depth, use progressive scan, use interlaced scan, etc.). Likewise, if the available network bandwidth falls below a bandwidth threshold, the security camera may decrease a quality aspect of the audio and/or video streams. Upon detecting a sound and/or detecting the human voice, however, the security camera may increase or decrease a quality aspect of the audio and/or video streams regardless of the available network bandwidth. Thus, the bandwidth consumed by the audio and/or video streams of the security camera may at certain times be reduced in order to provide additional bandwidth to other services on the network. Additionally, or alternatively, upon determining the sound detected by the microphone includes the human voice, the security camera may adjust an image resolution of the video stream, adjust a video frame rate of the video stream, adjust a video color depth of the video stream, etc. Accordingly, the bandwidth consumed by the video stream may be reduced overall in order to provide additional bandwidth to other services on the network.

According to the Nyquist-Shannon sampling theorem, the sampling frequency of an audio signal must be at least twice the audio signal's frequency range for effective reconstruction of the audio signal. In telephony, the usable voice frequency band ranges from approximately 300 Hz to 3400 Hz. The bandwidth allocated for a single voice-frequency transmission channel is usually 4 kHz, allowing a sampling rate of 8 kHz to be used, which is the sampling rate of the pulse code modulation system used for a digital public switched telephone network (PSTN). The methods and systems described herein may switch between various sampling frequencies based on the detection of human voice or speech. For example, captured audio may be encoded using a sampling rate of at least 48 kHz (e.g., digital video disc (DVD) quality), 44.1 kHz (e.g., compact disc (CD) quality), 32 kHz, 22.05 kHz, 11.025 kHz, 8 kHz (e.g., telephone system or microcassette quality), 4 kHz, or lower, etc.

Additionally, in some embodiments, audio may not be sampled at all when the system fails to detect human voice or speech. For example, in some cases the system may not sample any audio when the system does not detect human voice or speech, sound, and/or motion, and thus, the system may not transmit any audio when the system fails to detect human voice or speech and/or fails to detect sound above a noise threshold.

Audio sampling resolution, also known as bit depth, may represent the number of bits used to carry the data in each sample of audio. The bit depth chosen for recording limits the dynamic range of the recording. Some example bit depths may include 4-bit, 8-bit (e.g., telephone audio), 11-bit, 16-bit (e.g., CD quality), 20-bit, 24-bit (e.g., BLU-RAY® quality), 32-bit, 48-bit, 64-bit, etc. The methods and systems described herein may switch between various bit depths based on the detection of human voice or speech. For example, captured audio may be encoded using a bit depth of 16 bits per sample when human or voice speech is detected, and may encode audio using 4 bits when human or voice speech is not detected. Additionally, in some embodiments, as described above, audio may not be sampled at all when the system fails to detect human voice or speech. Thus, in some cases, no audio may be transmitted when the system does not detect human voice or speech and/or when the system does not detect any sound above a noise threshold.

In some embodiments, a video camera may be capable of capturing images at two or more different resolutions. For example, a camera of the systems and methods described herein may be capable of capturing images with 1920×1080 pixels of resolution or more as well as capturing images with resolutions of 1280×780, 1024×768, 960×480, 800×600, 720×480, 640×480, or less, etc. Accordingly, in one embodiment, the methods and systems described herein may switch between various image resolutions based on the detection of human voice or speech. For example, the system may capture images using a resolution of 1920×1080 pixels when human or voice speech is detected, and may capture images using a resolution of 640×480 when human or voice speech is not detected. Additionally, in some embodiments, as described above, images may not be captured at all when the system fails to detect human voice or speech. Thus, no video may be transmitted when the system does not detect human voice or speech and/or when the system does not detect any sound above a noise threshold.

Frame rate is the number of images or frames per second (fps) captured by a video camera. For example, Broadcast HD is transmitted at a rate of 59.94 fps in North America, and 50 fps in Europe. Thus, in some embodiments, the system may capture images at 1 fps, 10 fps, 20 fps, 24 fps, 25 fps, 30 fps (e.g., 29.97 fps in National Television System Committee systems), 50 fps, 60 fps (e.g., 59.94 fps in Broadcast HD systems), etc. In some cases, the system may switch between progressive and interlaced scanning to transmit video images. Interlacing is a way of sending only half of the video frame at a time, either the odd rows or the even rows of an image, whereas progressive scan transmits all the rows at once. Thus, interlacing reduces the number of full frames sent per second by half, and likewise cuts the bandwidth requirement in half. Accordingly, in some cases, the systems and methods described herein may be configured to capture images and send interlaced images when the system fails to detect human voice or speech, and send progressive scan images when the system detects human voice or speech.

Color depth, also known as pixel bit depth, is either the number of bits used to indicate the color of a single pixel (e.g., in a bitmapped image or video frame buffer), or the number of bits used for each color component of a single pixel. For consumer video standards, such as High Efficiency Video Coding (H.265), the bit depth may specify the number of bits used for each color component. When referring to a pixel the concept may be defined as bits per pixel (bpp), which specifies the number of bits used to define one pixel. When referring to a color component the concept may be defined as bits per channel (bpch), bits per color (bpc), or bits per sample (bps). For example, a color depth of 1-bit is also referred to as monochrome, where a pixel may be either black or white. An 8-bit color depth, also known as grayscale, generates 256 colors. Most color cameras have at least a 15- or 16-bit color depth. A 15- or 16-bit color, also known as high color, provides an adequate color scheme. A 24-bit color depth, also known as true color, provides over 16 million color variations per pixel. A 30-, 36-, or 48-bit color depth, also known as deep color, provides over a billion color variations per pixel. Accordingly, the methods and systems described herein may switch between various color depths based on the detection of human voice or speech (e.g., 1 bit, 2 bits, 4 bits, 8 bits, 16 bits, 18 bits, 24 bits, 30 bits, 32 bits, 36 bits, 48 bits, or more, etc.). As one example, the system may capture images that may be encoded using a color depth of 16 bits per pixel when human or voice speech is detected, and may capture images at 8 bits per pixel when human or voice speech is not detected. Additionally, in some embodiments, as described above, video may not be captured at all when the system fails to detect human voice or speech. Thus, in some cases, no video may be transmitted when the system does not detect human voice or speech and/or when the system does not detect any sound above a noise threshold.

The following description provides examples and is not limiting of the scope, applicability, and/or examples set forth in the claims. Changes may be made in the function and/or arrangement of elements discussed without departing from the scope of the disclosure. Various examples may omit, substitute, and/or add various procedures and/or components as appropriate. For instance, the methods described may be performed in an order different from that described, and/or various steps may be added, omitted, and/or combined. Also, features described with respect to some examples may be combined in other examples.

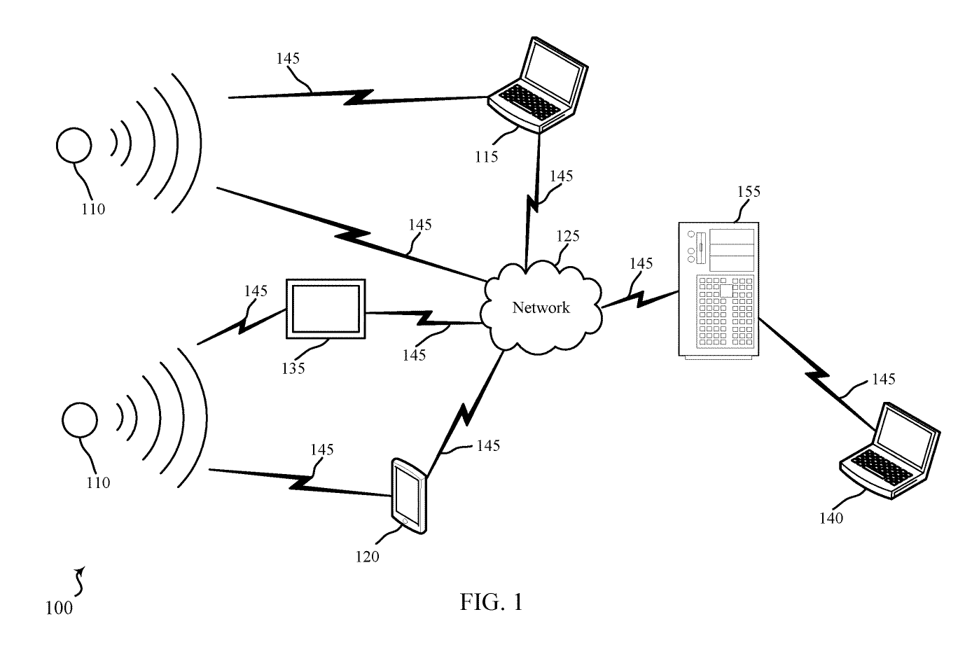

FIG. 1 is an example of a communications system 100 in accordance with various aspects of the disclosure. In some embodiments, the communications system 100 may include one or more sensor units 110, local computing device 115, 120, network 125, server 155, control panel 135, and remote computing device 140. One or more sensor units 110 may communicate via wired or wireless communication links 145 with one or more of the local computing device 115, 120 or network 125. The network 125 may communicate via wired or wireless communication links 145 with the control panel 135 and the remote computing device 140 via server 155. In alternate embodiments, the network 125 may be integrated with any one of the local computing device 115, 120, server 155, or remote computing device 140, such that separate components are not required.

Local computing device 115, 120 and remote computing device 140 may be custom computing entities configured to interact with sensor units 110 via network 125, and in some embodiments, via server 155. In other embodiments, local computing device 115, 120 and remote computing device 140 may be general purpose computing entities such as a personal computing device, for example, a desktop computer, a laptop computer, a netbook, a tablet personal computer (PC), a control panel, an indicator panel, a multi-site dashboard, an iPod®, an iPad®, a smart phone, a mobile phone, a personal digital assistant (PDA), and/or any other suitable device operable to send and receive signals, store and retrieve data, and/or execute modules.

Control panel 135 may be a smart home system panel, for example, an interactive panel mounted on a wall in a user's home. Control panel 135 may be in direct communication via wired or wireless communication links 145 with the one or more sensor units 110, or may receive sensor data from the one or more sensor units 110 via local computing devices 115, 120 and network 125, or may receive data via remote computing device 140, server 155, and network 125.

The local computing devices 115, 120 may include memory, a processor, an output, a data input and a communication module. The processor may be a general purpose processor, a Field Programmable Gate Array (FPGA), an Application Specific Integrated Circuit (ASIC), a Digital Signal Processor (DSP), and/or the like. The processor may be configured to retrieve data from and/or write data to the memory. The memory may be, for example, a random access memory (RAM), a memory buffer, a hard drive, a database, an erasable programmable read only memory (EPROM), an electrically erasable programmable read only memory (EEPROM), a read only memory (ROM), a flash memory, a hard disk, a floppy disk, cloud storage, and/or so forth. In some embodiments, the local computing devices 115, 120 may include one or more hardware-based modules (e.g., DSP, FPGA, ASIC) and/or software-based modules (e.g., a module of computer code stored at the memory and executed at the processor, a set of processor-readable instructions that may be stored at the memory and executed at the processor) associated with executing an application, such as, for example, receiving and displaying data from sensor units 110.

The processor of the local computing devices 115, 120 may be operable to control operation of the output of the local computing devices 115, 120. The output may be a television, a liquid crystal display (LCD) monitor, a cathode ray tube (CRT) monitor, speaker, tactile output device, and/or the like. In some embodiments, the output may be an integral component of the local computing devices 115, 120. Similarly stated, the output may be directly coupled to the processor. For example, the output may be the integral display of a tablet and/or smart phone. In some embodiments, an output module may include, for example, a High Definition Multimedia Interface™ (HDMI) connector, a Video Graphics Array (VGA) connector, a Universal Serial Bus™ (USB) connector, a tip, ring, sleeve (TRS) connector, and/or any other suitable connector operable to couple the local computing devices 115, 120 to the output.

The remote computing device 140 may be a computing entity operable to enable a remote user to monitor the output of the sensor units 110. The remote computing device 140 may be functionally and/or structurally similar to the local computing devices 115, 120 and may be operable to receive data streams from and/or send signals to at least one of the sensor units 110 via the network 125. The network 125 may be the Internet, an intranet, a personal area network, a local area network (LAN), a wide area network (WAN), a virtual network, a telecommunications network implemented as a wired network and/or wireless network, etc. The remote computing device 140 may receive and/or send signals over the network 125 via communication links 145 and server 155.

In some embodiments, the one or more sensor units 110 may be sensors configured to conduct periodic or ongoing automatic measurements related to security cameras in system 100. Sensor units 110 may include one or more camera sensors, audio sensors, monitor sensors, proximity sensors, microphones, etc. In some cases, sensor units 110 may include a data receiver, data transmitter, and/or data transceiver, etc. Each sensor unit 110 may be capable of sensing multiple audio and/or video parameters, or alternatively, separate sensor units 110 may monitor separate audio/video parameters. For example, one sensor unit 110 may capture audio, while another sensor unit 110 (or, in some embodiments, the same sensor unit 110) may capture video and/or images. In some embodiments, one or more sensor units 110 may additionally monitor alternate parameters, such as motion and/or proximity. In alternate embodiments, a user may request data from sensor units 110 at the local computing device 115, 120 or at remote computing device 140. For example, a user may enter a request for data into a dedicated application on his smart phone indicating a request for audio and/or video data from sensor units 110.

Data gathered by the one or more sensor units 110 may be communicated to local computing device 115, 120, which may be, in some embodiments, a control panel or any device associated with an automation system with a screen and/or speakers such as a wall-mounted input/output smart home display, etc. In other embodiments, local computing device 115, 120 may be a personal computer or smart phone. Where local computing device 115, 120 is a smart phone, the smart phone may have a dedicated application directed to collecting audio and/or video data and displaying images and/or playing audio therefrom. The local computing device 115, 120 may process the data received from the one or more sensor units 110 to detect details regarding captured audio such as detecting a human voice. In alternate embodiments, remote computing device 140 may process the data received from the one or more sensor units 110, via network 125 and server 155, to determine voice detection. Data transmission may occur via, for example, frequencies appropriate for a personal area network (such as BLUETOOTH® or IR communications) or local or wide area network frequencies such as radio frequencies specified by the IEEE 802.15.4 standard.

In some embodiments, local computing device 115, 120 may communicate with remote computing device 140 or control panel 135 via network 125 and server 155. Examples of networks 125 include cloud networks, local area networks (LAN), wide area networks (WAN), virtual private networks (VPN), wireless networks (using 802.11, for example), and/or cellular networks (using 3G and/or LTE, for example), etc. In some configurations, the network 125 may include the Internet. In some embodiments, a user may access the functions of local computing device 115, 120 from remote computing device 140. For example, in some embodiments, remote computing device 140 may include a mobile application that interfaces with one or more functions of local computing device 115, 120.

The server 155 may be configured to communicate with the sensor units 110, the local computing devices 115, 120, the remote computing device 140 and control panel 135. The server 155 may perform additional processing on signals received from the sensor units 110 or local computing devices 115, 120, or may simply forward the received information to the remote computing device 140 and control panel 135.

Server 155 may be a computing device operable to receive data streams (e.g., from sensor units 110 and/or local computing device 115, 120 or remote computing device 140), store and/or process data, and/or transmit data and/or data summaries (e.g., to remote computing device 140). For example, server 155 may receive a stream of audio/video data from a sensor unit 110, a stream of audio/video data from the same or a different sensor unit 110, and a stream of audio/video data from either the same or yet another sensor unit 110. In some embodiments, server 155 may “pull” the data streams, e.g., by querying the sensor units 110, the local computing devices 115, 120, and/or the control panel 135. In some embodiments, the data streams may be “pushed” from the sensor units 110 and/or the local computing devices 115, 120 to the server 155. For example, the sensor units 110 and/or the local computing device 115, 120 may be configured to transmit data as it is generated by or entered into that device. In some instances, the sensor units 110 and/or the local computing devices 115, 120 may periodically transmit data (e.g., as a block of data or as one or more data points).

The server 155 may include a database (e.g., in memory) containing audio/video data received from the sensor units 110 and/or the local computing devices 115, 120. Additionally, as described in further detail herein, software (e.g., stored in memory) may be executed on a processor of the server 155. Such software (executed on the processor) may be operable to cause the server 155 to monitor, process, summarize, present, and/or send a signal associated with resource usage data.

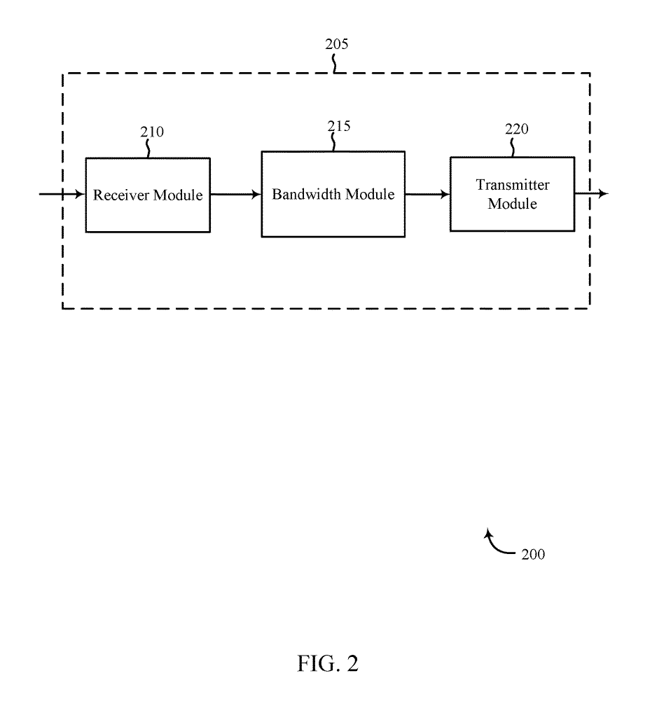

FIG. 2 shows a block diagram 200 of an apparatus 205 for use in electronic communication, in accordance with various aspects of this disclosure. In one embodiment, apparatus 205 may include a security camera in an automation system of a premises. In some cases, the apparatus 205 may be an example of one or more aspects of control panel 105 described with reference to FIG. 1. In some embodiments, apparatus 205 may be an example of a server, a desktop, a laptop, and/or a mobile computing device, as illustrated by device 115 of FIG. 1. The apparatus 205 may include a receiver module 210, a bandwidth module 215, and/or a transmitter module 220. The apparatus 205 may also be or include a processor. Each of these modules may be in communication with each other directly and/or indirectly.

The components of the apparatus 205 may, individually or collectively, be implemented using one or more application-specific integrated circuits (ASICs) adapted to perform some or all of the applicable functions in hardware. Alternatively, the functions may be performed by one or more other processing units (or cores), on one or more integrated circuits. In other examples, other types of integrated circuits may be used (e.g., Structured/Platform ASICs, Field Programmable Gate Arrays (FPGAs), and other Semi-Custom ICs), which may be programmed in any manner known in the art. The functions of each module may also be implemented—in whole or in part—with instructions embodied in memory formatted to be executed by one or more general and/or application-specific processors.

The receiver module 210 may receive information such as packets, user data, and/or control information associated with various information channels (e.g., control channels, data channels, etc.). The receiver module 210 may be configured to receive information regarding available bandwidth, commands, data requests, captured audio, captured video/images, etc. Information may be passed on to the bandwidth module 215, and to other components of the apparatus 205.

The bandwidth module 215 may monitor bandwidth of a communication network available to apparatus 205. Upon detecting sound, bandwidth module 215 may determine whether the sound includes a human voice. Upon determining the sound includes a human voice, bandwidth module 215 may automatically increase the quality of one or more aspects regarding audio and/or video captured by apparatus 205, and thereby increase the bandwidth usage of apparatus 205. Upon determining no sound is detected (e.g., detectable sound is below a sound threshold) and/or the sound does not include a human voice, bandwidth module 215 may be pre-configured to automatically decrease the quality of one or more aspects regarding audio and/or video captured by apparatus 205 in real-time without human input and/or intervention. In some cases, upon determining no sound is detected and/or no voice is detected, the bandwidth module 215 may revert to a default mode that minimizes bandwidth usage of apparatus 205. In some cases, upon detecting voice, bandwidth module 215 may determine whether the voice is of a known or unknown person (e.g., whether the voice is that of an occupant of the premises or unknown). Upon determining the voice is that of an occupant, bandwidth module 215 may query for user preferences of the identified occupant and perform one or more automation tasks based on the user preferences and present conditions (e.g., time of day, outdoor temperature, indoor temperature, whether occupant is alone, priority between multiple occupants, etc.). Upon determining the voice is unknown, bandwidth module 215 may trigger a capture event, including capturing audio, images, and/or video of the unknown visitor. Upon detecting the unknown visitor, bandwidth module 215 may increase the quality of one or more aspects of the captured audio and/or video.

The transmitter module 220 may transmit the one or more signals received from other components of the apparatus 205. The transmitter module 220 may transmit streams of audio and/or video captured by apparatus 205. In some examples, the transmitter module 220 may be collocated with the receiver module 210 in a transceiver module.

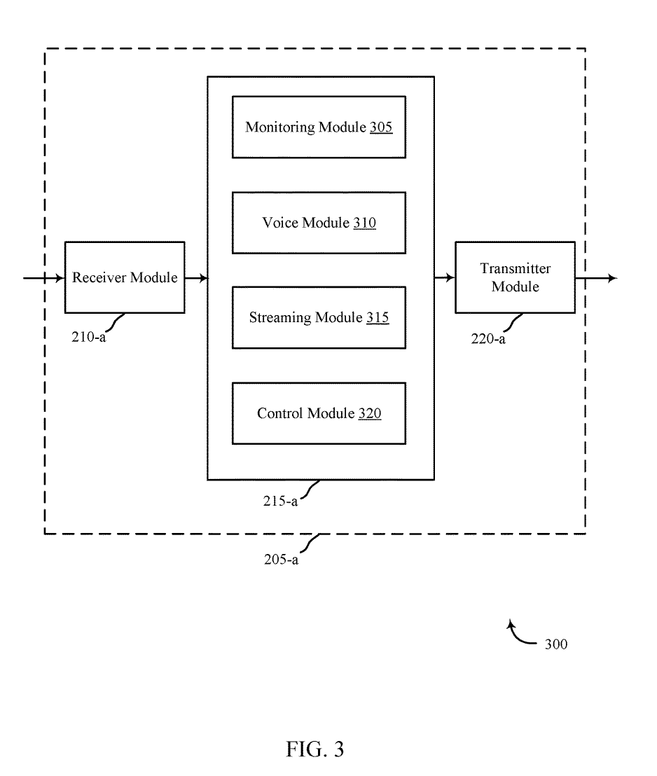

FIG. 3 shows a block diagram 300 of an apparatus 205-a for use in wireless communication, in accordance with various examples. The apparatus 205-a may be an example of one or more aspects of a control panel 105 described with reference to FIG. 1. It may also be an example of an apparatus 205 described with reference to FIG. 2. The apparatus 205-a may include a receiver module 210-a, a bandwidth module 215-a, and/or a transmitter module 220-a, which may be examples of the corresponding modules of apparatus 205. The apparatus 205-a may also include a processor. Each of these components may be in communication with each other. The bandwidth module 215-a may include monitoring module 305, voice module 310, streaming module 315, control module 320. The receiver module 210-a and the transmitter module 220-a may perform the functions of the receiver module 210 and the transmitter module 220, of FIG. 2, respectively.

In conjunction with the illustrated modules, bandwidth module 215-a may be reduce bandwidth usage of a device in an automation system based on audio detection. In one embodiment, monitoring module 305 may monitor for detection of sound via a microphone on a security camera. The security camera may be configured to generate an audio stream and/or a video stream and to transmit the audio and/or video streams via a wired and/or wireless transmitter associated with the security camera. Upon detecting sound via the microphone, voice module 310 may determine whether the sound includes a human voice. Bandwidth module 215-a may reduce bandwidth usage of the security camera based on the detection of a human voice.

In one embodiment, upon determining the sound includes the human voice, streaming module 315 may modify at least one aspect of the audio and/or video streams of the security camera. For example, upon determining the sound includes the human voice, streaming module 315 may adjust an audio sampling rate of the audio stream, adjust an image resolution of the video stream, and/or adjust a video frame rate of the video stream. Upon determining the sound detected by the microphone falls below a sound threshold, streaming module 315 may configure at least one of the audio and video streams to a default mode. As one example, the default mode may include transmitting a relatively low quality audio and/or video signal. In some cases, the default mode may include transmitting no audio and/or no video.

In one embodiment, monitoring module 305 may monitor a network to which the security camera is connected to determine the network's available bandwidth. For example, the security camera may be connected to a wired and/or wireless data communication network at a home, school, or office. The bandwidth may be limited by the bit rate of a network device in the network such as a router, switch, modem, etc. The bandwidth may be limited by the number of device connected to and/or using the network. Upon determining the sound detected by the microphone falls below a sound threshold, streaming module 315 may modify at least one aspect of the audio or video streams of the security camera based on the available bandwidth. For example, upon determining the available bandwidth exceeds a predetermined threshold (e.g., 75% or more of maximum bandwidth available), then streaming module 315 may increase the quality of one or more aspects of the audio and/or video streams. Likewise, upon determining the available bandwidth falls below a predetermined threshold (e.g., 35% or less of max bandwidth available), then streaming module 315 may decrease the quality of one or more aspects of the audio and/or video streams. In some cases, streaming module 315 may adjust the audio and video stream settings based on two or more thresholds (e.g., low quality audio/video stream settings for 30% or less available bandwidth, medium quality audio/video stream settings for available bandwidth between 31% and 65%, and high quality audio/video stream settings for available bandwidth of 66% or more). Upon determining the sound detected by the microphone includes the human voice, streaming module 315 may modify at least one aspect of the audio or video streams of the security camera regardless of the available bandwidth. Thus, even if the available bandwidth is relatively low (e.g., below 25% of maximum bandwidth), streaming module 315 may increase the quality of the audio and/or video streams upon detecting a human voice, sound above a threshold, and/motion.

In one embodiment, upon determining the sound includes the human voice, streaming module 315 may send a command to a control panel to perform an automation action. As one example, upon identifying the detected human voice as a known voice, voice module 310 may determine whether the known voice is associated with a first occupant or a second occupant of the premises. Upon determining the known voice is associated with the first occupant, control module 320 may send a command to the control panel to perform a first automation action. Upon determining the known voice is associated with the second occupant, control module 320 may send a command to the control panel to perform a second automation action. Upon detecting the voices of both first and second occupants, control module 320 may determine whether a conflict exists between the stored preferences of the first occupant in relation to the stored preferences of the second occupant, and if so, whether a priority configuration regarding multiple occupants exists. Upon identifying a conflict in preferences and determining the preferences of the first occupant supersede those of the second, the control module 320 may implement the preferences of the first occupant over those which conflict with the preferences of the second occupant. Upon identifying the detected human voice as an unknown voice, control module 320 may trigger a capture event in relation to the security camera. For example, control module 320 may trigger the camera and/or automation system to capture audio, images, video, etc., of the unknown visitor and to generate one or more notifications based on the captured data.

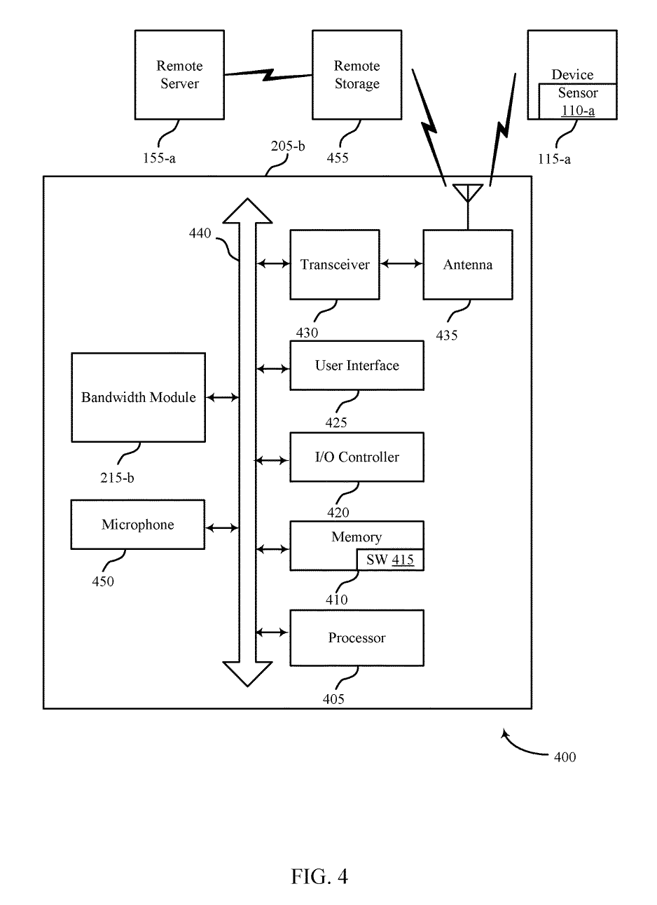

FIG. 4 shows a system 400 for use in automation systems, in accordance with various examples. System 400 may include an apparatus 205-b. The apparatus 205-b may be an example of one or more aspects of control panel 135 of FIG. 1. In some cases, apparatus 205-b may be an example of one or more aspects of apparatus 205 of FIG. 2 and/or 205-a of FIG. 3. In some embodiments, apparatus 205-b may be an example of a computing device such as a mobile device, laptop, desktop, etc., as illustrated by devices 115, 120, 130, or 140 of FIG. 1. Apparatus 205-b may include microphone 450, which may be an example of sensor units 110 described with reference to FIG. 1. Microphone 450 may be configured to capture audio such as a human voice. In some embodiments, the terms a control panel and a control device are used synonymously.

The apparatus 205-b may include a bandwidth module 215-b, which may perform the functions described above for the bandwidth modules 215 of apparatus 205 of FIGS. 2 and 3. Apparatus 205-b may also include components for bi-directional voice and data communications including components for transmitting communications and components for receiving communications. For example, apparatus 205-b may communicate bi-directionally with one or more of device 115-a, one or more sensors 110-a, remote storage 455, and/or remote server 155-a, which may be an example of the remote server of FIG. 1. This bi-directional communication may be direct (e.g., apparatus 205-b communicating directly with remote storage 455) or indirect (e.g., apparatus 205-b communicating indirectly with remote server 155-a through remote storage 455).

Apparatus 205-b may also include a processor module 405, and memory 410 (including software/firmware code (SW) 415), an input/output controller module 420, a user interface module 425, a transceiver module 430, and one or more antennas 435 each of which may communicate—directly or indirectly—with one another (e.g., via one or more buses 440). The transceiver module 430 may communicate bi-directionally—via the one or more antennas 435, wired links, and/or wireless links—with one or more networks or remote devices as described above. For example, the transceiver module 430 may communicate bi-directionally with one or more of device 115-a, remote storage 455, and/or remote server 155-a. The transceiver module 430 may include a modem to modulate the packets and provide the modulated packets to the one or more antennas 435 for transmission, and to demodulate packets received from the one or more antenna 435. While a control panel or a control device (e.g., 205-b) may include a single antenna 435, the control panel or the control device may also have multiple antennas 435 capable of concurrently transmitting or receiving multiple wired and/or wireless transmissions. In some embodiments, one element of apparatus 205-b (e.g., one or more antennas 435, transceiver module 430, etc.) may provide a direct connection to a remote server 155-a via a direct network link to the Internet via a POP (point of presence). In some embodiments, one element of apparatus 205-b (e.g., one or more antennas 435, transceiver module 430, etc.) may provide a connection using wireless techniques, including digital cellular telephone connection, Cellular Digital Packet Data (CDPD) connection, digital satellite data connection, and/or another connection.

The signals associated with system 400 may include wireless communication signals such as radio frequency, electromagnetics, local area network (LAN), wide area network (WAN), virtual private network (VPN), wireless network (using 802.11, for example), 345 MHz, Z-WAVE®, cellular network (using 3G and/or LTE, for example), and/or other signals. The one or more antennas 435 and/or transceiver module 430 may include or be related to, but are not limited to, WWAN (GSM, CDMA, and WCDMA), WLAN (including BLUETOOTH® and Wi-Fi), WMAN (WiMAX), antennas for mobile communications, antennas for Wireless Personal Area Network (WPAN) applications (including RFID and UWB). In some embodiments, each antenna 435 may receive signals or information specific and/or exclusive to itself. In other embodiments, each antenna 435 may receive signals or information not specific or exclusive to itself.

In some embodiments, one or more sensors 110-a (e.g., camera, microphone, audio, motion, proximity, smoke, light, glass break, door, window, carbon monoxide, and/or another sensor) may connect to some element of system 400 via a network using one or more wired and/or wireless connections. In some embodiments, a sensor 110-a may be an example of sensors 110 of FIG. 1.

In some embodiments, the user interface module 425 may include an audio device, such as an external speaker system, a microphone (in addition to and/or including microphone 450), an external display device such as a display screen, and/or an input device (e.g., remote control device interfaced with the user interface module 425 directly and/or through I/O controller module 420).

One or more buses 440 may allow data communication between one or more elements of apparatus 205-b (e.g., processor module 405, memory 410, I/O controller module 420, user interface module 425, etc.).

The memory 410 may include random access memory (RAM), read only memory (ROM), flash RAM, and/or other types. The memory 410 may store computer-readable, computer-executable software/firmware code 415 including instructions that, when executed, cause the processor module 405 to perform various functions described in this disclosure (e.g., performing one or more functions described above with respect to reducing bandwidth consumption of a device configured to capture and stream audio and/or video in an automation system, etc.). Alternatively, the software/firmware code 415 may not be directly executable by the processor module 405 but may cause a computer (e.g., when compiled and executed) to perform functions described herein. Alternatively, the computer-readable, computer-executable software/firmware code 415 may not be directly executable by the processor module 405 but may be configured to cause a computer (e.g., when compiled and executed) to perform functions described herein.

In some embodiments, the processor module 405 may include, among other things, an intelligent hardware device (e.g., a central processing unit (CPU), a microcontroller, and/or an ASIC, etc.). The memory 410 can contain, among other things, the Basic Input-Output system (BIOS) which may control basic hardware and/or software operation such as the interaction with peripheral components or devices. For example, the functions of bandwidth module 215-b to implement the present systems and methods may be stored within the system memory 410. Applications resident with system 400 are generally stored on and accessed via a non-transitory computer readable medium, such as a hard disk drive or other storage medium. Additionally, applications can be in the form of electronic signals modulated in accordance with the application and data communication technology when accessed via a network interface (e.g., transceiver module 430, one or more antennas 435, etc.).

Many other devices and/or subsystems may be connected to one or may be included as one or more elements of system 400 (e.g., entertainment system, computing device, remote cameras, wireless key fob, wall mounted user interface device, cell radio module, battery, alarm siren, door lock, lighting system, thermostat, home appliance monitor, utility equipment monitor, and so on). In some embodiments, all of the elements shown in FIG. 4 need not be present to practice the present systems and methods. The devices and subsystems can be interconnected in different ways from that shown in FIG. 4. In some embodiments, an aspect of some operation of a system, such as that shown in FIG. 4, may be readily known in the art and are not discussed in detail in this application. Code to implement the present disclosure can be stored in a non-transitory computer-readable medium such as one or more of system memory 410 or other memory. The operating system provided on I/O controller module 420 may be iOS®, ANDROID®, MS-DOS®, MS-WINDOWS®, OS/2®, UNIX®, LINUX®, or another known operating system.

The transceiver module 430 may include a modem configured to modulate the packets and provide the modulated packets to the antennas 435 for transmission and/or to demodulate packets received from the antennas 435. While the devices 115-a may include a single antenna 435, the devices 115-a may have multiple antennas 435 capable of concurrently transmitting and/or receiving multiple wireless transmissions.

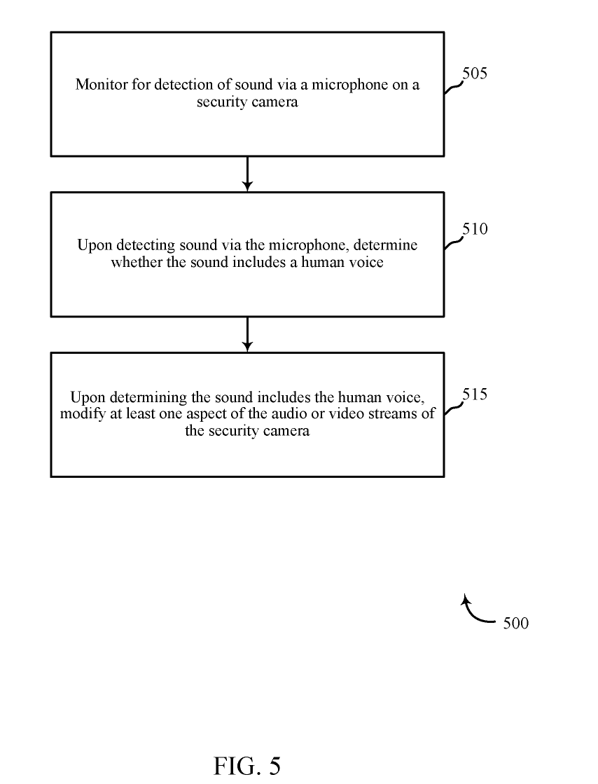

FIG. 5 is a flow chart illustrating an example of a method 500 reducing bandwidth usage via voice detection in relation to automation/security systems, in accordance with various aspects of the present disclosure. For clarity, the method 500 is described below with reference to aspects of one or more of the elements and features described with reference to FIGS. 1 and/or 2, and/or aspects of one or more of the elements and features described with reference to FIGS. 3 and/or 4. In some examples, a control panel, backend server, device, and/or sensor may execute one or more sets of codes to control the functional elements of the control panel, backend server, device, and/or sensor to perform the functions described below. Additionally or alternatively, the control panel, backend server, device, and/or sensor may perform one or more of the functions described below using special-purpose hardware. The operation(s) at blocks 505, 510, and/or 515 may be performed using the bandwidth module 215 described with reference to FIGS. 2, 3, and/or 4.

At block 505, detection of sound may be monitored via a microphone on a security camera. The security camera may be configured to generate an audio stream and a video stream and to transmit the audio and video streams via a transmitter associated with the security camera. At block 510, upon detecting sound via the microphone, whether the sound includes a human voice may be determined. At block 515, upon determining the sound includes the human voice, at least one aspect of the audio or video streams of the security camera may be modified. Upon determining the sound includes the human voice, the method may include adjusting an audio sampling rate of the audio stream, adjusting an image resolution of the video stream, and/or adjusting a video frame rate of the video stream.

Thus, the method 500 may provide for reducing bandwidth usage via voice detection in relation to automation/security systems. It should be noted that the method 500 is just one implementation and that the operations of the method 500 may be rearranged or otherwise modified such that other implementations are possible.

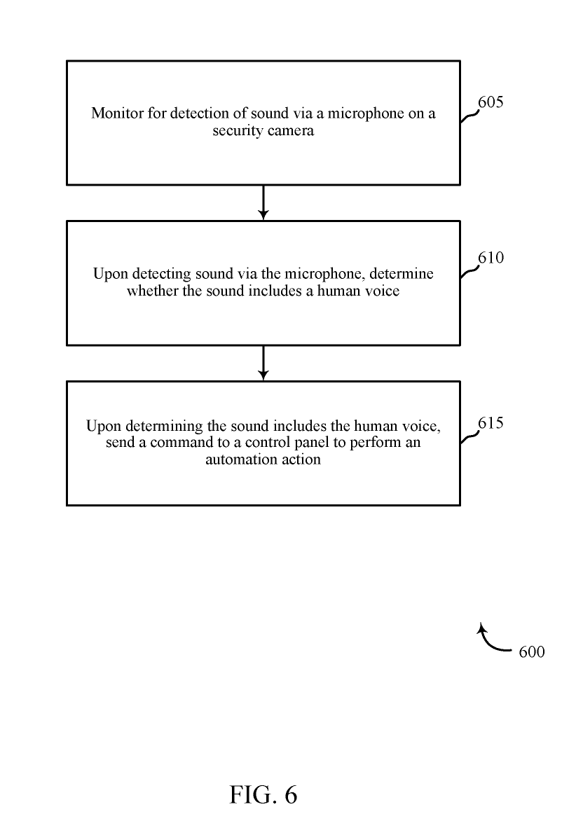

FIG. 6 is a flow chart illustrating an example of a method 600 for triggering capture events via voice detection in relation to automation/security systems, in accordance with various aspects of the present disclosure. For clarity, the method 600 is described below with reference to aspects of one or more of the elements and features described with reference to FIGS. 1 and/or 2, and/or aspects of one or more of the elements and features described with reference to FIGS. 3 and/or 4. In some examples, a control panel, backend server, device, and/or sensor may execute one or more sets of codes to control the functional elements of the control panel, backend server, device, and/or sensor to perform the functions described below. Additionally or alternatively, the control panel, backend server, device, and/or sensor may perform one or more of the functions described below using special-purpose hardware. The operation(s) at blocks 605, 610, and/or 615 may be performed using the bandwidth module 215 described with reference to FIGS. 2, 3, and/or 4.

At block 605, detection of sound may be monitored via a microphone on a security camera. The security camera may be configured to generate an audio stream and a video stream and to transmit the audio and video streams via a transmitter associated with the security camera. At block 610, upon detecting sound via the microphone, whether the sound includes a human voice may be determined. At block 615, upon determining the sound includes the human voice, a command may be sent to a control panel to perform an automation action.

Thus, the method 600 may provide for triggering capture events via voice detection in relation to automation/security systems. It should be noted that the method 600 is just one implementation and that the operations of the method 600 may be rearranged or otherwise modified such that other implementations are possible.

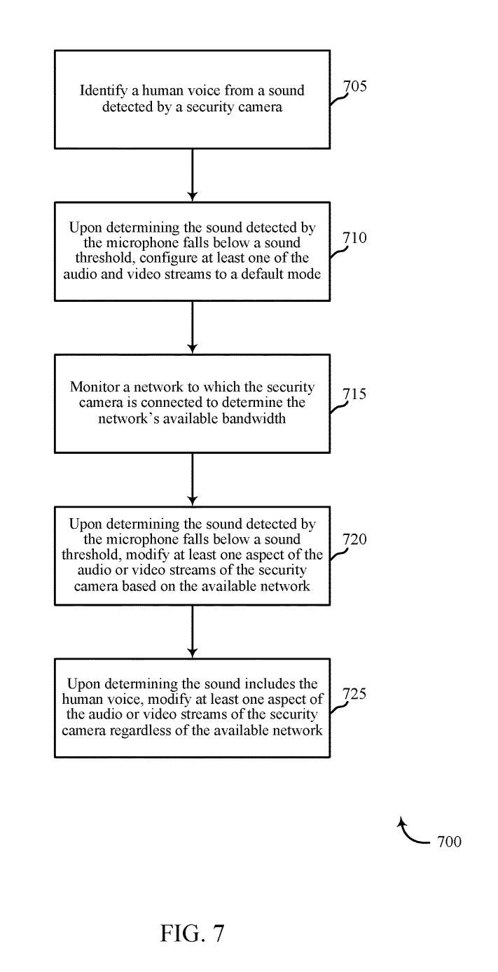

FIG. 7 is a flow chart illustrating an example of a method 700 for reducing bandwidth usage via voice detection in relation to automation/security systems, in accordance with various aspects of the present disclosure. For clarity, the method 700 is described below with reference to aspects of one or more of the elements and features described with reference to FIGS. 1 and/or 2, and/or aspects of one or more of the elements and features described with reference to FIGS. 3 and/or 4. In some examples, a control panel, backend server, device, and/or sensor may execute one or more sets of codes to control the functional elements of the control panel, backend server, device, and/or sensor to perform the functions described below. Additionally or alternatively, the control panel, backend server, device, and/or sensor may perform one or more of the functions described below using special-purpose hardware. The operation(s) at blocks 705, 710, 715, 720, and/or 725 may be performed using the bandwidth module 215 described with reference to FIGS. 2, 3, and/or 4.

At block 705, a human voice may be identified from a sound detected by a security camera. At block 710, upon determining the sound detected by the microphone falls below a sound threshold, at least one of the audio and video streams may be configured to a default mode. In some cases, the method may include determining whether the sound detected by the microphone falls below the sound threshold and/or the sound does not include a human voice for a predetermined time period. The default mode may include one or more audio and/or video stream settings that result in a reduction of bandwidth consumed by the security camera. Thus, in one example, setting the audio and/or video streams to a default mode may include reducing an audio sampling rate of the audio stream, reducing a bit rate of the audio stream, reducing an image resolution of the video stream, and/or reducing a video frame rate of the video stream. The method may include reverting the audio and/or video streams to a default mode automatically, in real-time, without human input or intervention besides pre-configuration such as configuring the security camera ahead of time to revert to the default mode upon detecting no voice and/or detecting the sound below the sound threshold. At block 715, a network to which the security camera is connected may be monitored to determine the network's available bandwidth. At block 720, upon determining the sound detected by the microphone falls below a sound threshold, at least one aspect of the audio or video streams of the security camera may be modified based on the available network. At block 725, upon determining the sound includes the human voice, at least one aspect of the audio or video streams of the security camera may be modified regardless of the available network.

Thus, the method 700 may provide for reducing bandwidth usage via voice detection in relation to automation/security systems. It should be noted that the method 700 is just one implementation and that the operations of the method 700 may be rearranged or otherwise modified such that other implementations are possible.

In some examples, aspects from two or more of the methods 500, 600, and/or 700 may be combined and/or separated. It should be noted that the methods 500, 600, and/or 700 are just example implementations, and that the operations of the methods 500, 600, and/or 700 may be rearranged or otherwise modified such that other implementations are possible.

The detailed description set forth above in connection with the appended drawings describes examples and does not represent the only instances that may be implemented or that are within the scope of the claims. The terms “example” and “exemplary,” when used in this description, mean “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and apparatuses are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and components described in connection with this disclosure may be implemented or performed with a general-purpose processor, a digital signal processor (DSP), an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, and/or state machine. A processor may also be implemented as a combination of computing devices, e.g., a combination of a DSP and a microprocessor, multiple microprocessors, one or more microprocessors in conjunction with a DSP core, and/or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items (for example, a list of items prefaced by a phrase such as “at least one of” or “one or more of”) indicates a disjunctive list such that, for example, a list of “at least one of A, B, or C” means A or B or C or AB or AC or BC or ABC (i.e., A and B and C).

In addition, any disclosure of components contained within other components or separate from other components should be considered exemplary because multiple other architectures may potentially be implemented to achieve the same functionality, including incorporating all, most, and/or some elements as part of one or more unitary structures and/or separate structures.

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, flash memory, CD-ROM, DVD, or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel features disclosed.

This disclosure may specifically apply to security system applications. This disclosure may specifically apply to automation system applications. In some embodiments, the concepts, the technical descriptions, the features, the methods, the ideas, and/or the descriptions may specifically apply to security and/or automation system applications. Distinct advantages of such systems for these specific applications are apparent from this disclosure.

The process parameters, actions, and steps described and/or illustrated in this disclosure are given by way of example only and can be varied as desired. For example, while the steps illustrated and/or described may be shown or discussed in a particular order, these steps do not necessarily need to be performed in the order illustrated or discussed. The various exemplary methods described and/or illustrated here may also omit one or more of the steps described or illustrated here or include additional steps in addition to those disclosed.

Furthermore, while various embodiments have been described and/or illustrated here in the context of fully functional computing systems, one or more of these exemplary embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may permit and/or instruct a computing system to perform one or more of the exemplary embodiments disclosed here.

This description, for purposes of explanation, has been described with reference to specific embodiments. The illustrative discussions above, however, are not intended to be exhaustive or limit the present systems and methods to the precise forms discussed. Many modifications and variations are possible in view of the above teachings. The embodiments were chosen and described in order to explain the principles of the present systems and methods and their practical applications, to enable others skilled in the art to utilize the present systems, apparatus, and methods and various embodiments with various modifications as may be suited to the particular use contemplated.

What is claimed is:

1. A method for reducing bandwidth usage based on audio detection, comprising:
monitoring for detection of sound via a microphone on a security camera, wherein the security camera is configured to generate an audio stream and a video stream and to transmit the audio stream and the video stream via a transmitter associated with the security camera;
upon detecting sound via the microphone, determining whether the sound includes a human voice; and
upon determining the sound includes the human voice, modifying at least one aspect of the audio stream or the video stream of the security camera.

2. The method of claim 1, comprising:
upon determining the sound includes the human voice, adjusting an audio sampling rate of the audio stream.

3. The method of claim 1, comprising:
upon determining the sound includes the human voice, adjusting an image resolution of the video stream.

4. The method of claim 1, comprising:
upon determining the sound includes the human voice, adjusting a video frame rate of the video stream.

5. The method of claim 1, comprising:
upon determining the sound detected by the microphone falls below a sound threshold, configuring at least one of the audio stream or the video stream to a default mode.

6. The method of claim 1, comprising:
monitoring a network to which the security camera is connected to determine the network's available bandwidth.

7. The method of claim 6, comprising:
upon determining the sound detected by the microphone falls below a sound threshold, modifying at least one aspect of the audio stream or the video stream of the security camera based on the available bandwidth.

8. The method of claim 6, comprising:
upon determining the sound includes the human voice, modifying at least one aspect of the audio stream or the video stream of the security camera regardless of the available bandwidth.

9. A method for triggering capture events based on audio detection, comprising:
monitoring for detection of sound via a microphone on a security camera in a premises, wherein the security camera is configured to generate an audio stream via the microphone and to transmit the audio stream via a wireless transmitter;
upon detecting sound via the microphone, determining whether the sound includes a human voice; and
upon determining the sound includes the human voice, sending a command to a control panel to perform an automation action.

10. The method of claim 9, comprising:
upon identifying the detected human voice as a known voice, determining whether the known voice is associated with a first occupant or a second occupant of the premises.

11. The method of claim 10, comprising:
upon determining the known voice is associated with the first occupant, sending the command to the control panel to perform a first automation action.

12. The method of claim 10, comprising:
upon determining the known voice is associated with the second occupant, sending the command to the control panel to perform a second automation action.

13. The method of claim 9, comprising:
upon identifying the detected human voice as an unknown voice, triggering a capture event in relation to the security camera.

14. An apparatus for security and/or automation systems, comprising:
a processor;
memory in electronic communication with the processor; and
instructions stored in the memory, the instructions being executable by the processor to:
monitor for detection of sound via a microphone on a security camera, wherein the security camera is configured to generate an audio stream and a video stream and to transmit the audio stream and the video stream via a transmitter associated with the security camera;
upon detecting sound via the microphone, determine whether the sound includes a human voice; and
upon determining the sound includes the human voice, modify at least one aspect of the audio stream or the video stream of the security camera.

15. The apparatus of claim 14, the instructions being executable by the processor to:
upon determining the sound includes the human voice, adjust an audio sampling rate of the audio stream.

16. The apparatus of claim 14, the instructions being executable by the processor to:
upon determining the sound includes the human voice, adjust an image resolution of the video stream.

17. The apparatus of claim 14, the instructions being executable by the processor to:
upon determining the sound includes the human voice, adjust a video frame rate of the video stream.

18. The apparatus of claim 14, the instructions being executable by the processor to:
upon determining the sound detected by the microphone falls below a sound threshold, configure at least one of the audio stream or the video stream to a default mode.

19. The apparatus of claim 14, the instructions being executable by the processor to:
monitor a network to which the security camera is connected to determine the network's available bandwidth.

20. The apparatus of claim 19, the instructions being executable by the processor to:
upon determining the sound detected by the microphone falls below a sound threshold, modify at least one aspect of the audio stream or the video stream of the security camera based on the available bandwidth.
